(19) United States
(12) Patent Application Publication
(10) Pub. No.: US 2024/0165618 A1
(43) Pub. Date: May 23, 2024

(54) MODULAR MANIFOLD FOR USE WITH A MICROFLUIDICS CHIP AND HAVING TWO-WAY AND THREE-WAY PLATE MANIFOLDS AND METHOD OF MAKING THE SAME

(71) Applicant: ASCO, LP., Florham Park, NJ (US)

(72) Inventor: Matthew T. Hoskins, Ann Arbor, MI (US)

(21) Appl. No.: 18/516,851

(22) Filed: Nov. 21, 2023

Related U.S. Application Data
(60) Provisional application No. 63/427,094, filed on Nov. 21, 2022.

(51) Int. Cl. B01L 3/00

(52) U.S. Cl. CPC B01L 3/502738; B01L 3/502707; B01L 2200/027; B01L 2200/028; B01L 2200/04; B01L 2200/12; B01L 2400/0666

(57) ABSTRACT

A modular manifold having two-way and three-way plate manifolds and a method of making the same. The modular manifold is intended to replace the large array of valves (interconnected with tubing) typically needed in medical, industrial, or analytical applications, thereby reducing the required footprint. The modular manifold includes one or more flow manipulation gaskets having configurable areas that can be configured to selectively manipulate fluid flowing therethrough in a desired manner.

### FIELD OF THE DISCLOSURE

The present disclosure is generally directed to a manifold and, more particularly, to a modular manifold for use with a microfluidics chip.

### BACKGROUND OF THE DISCLOSURE

Fluid control devices (e.g., control valves) are often employed to control the flow of fluids in medical, industrial, and analytical applications. In some cases, a manifold may be utilized to fluidly couple a plurality of fluid control devices together in a compact, organized manner. For example, the manifold may fluidly couple the plurality of fluid control devices together in a compact, organized manner that simultaneously fluidly couples a common fluid source to the plurality of fluid flow passageways of the plurality of fluid control devices.

### SUMMARY OF THE DISCLOSURE

In accordance with a first exemplary aspect of the present disclosure, a modular manifold assembly is provided for use with a microfluidic chip. The modular manifold assembly includes a manifold body, one or more valve seats carried by the manifold body, a first common manifold inlet formed in the manifold body, a second common manifold inlet formed in the manifold body, a plurality of manifold outlets formed in the manifold body, and one or more valves disposed in the manifold body. Each of the one or more valves is movable between a first state and a second state, wherein in the first state, the respective valve engages a respective valve seat of the one or more valve seats, thereby preventing fluid from flowing from the first common manifold inlet to the plurality of outlets but allowing fluid to flow from the second common manifold inlet to the plurality of outlets, and wherein in the second state, the respective valve is spaced from the respective valve seat of the one or more valve seats, thereby allowing fluid to flow from the first common manifold inlet to the plurality of outlets but preventing fluid from flowing from the second common manifold inlet to the plurality of outlets. The modular manifold further includes a flow manipulation gasket arranged within the manifold body and adjacent the one or more valves, the flow manipulation gasket comprising a gasket body configured to engage the manifold body and a plurality of configurable areas formed in the gasket body, the plurality of configurable areas configured to route fluid flowing to the plurality of outlets along one or more desired/pre-determined flow paths.

In accordance with a second exemplary aspect of the present disclosure, a modular manifold is provided for use with a microfluidic chip. The modular manifold includes a first manifold assembly, a second manifold assembly, and a printed circuit board captured between the first and second manifold assemblies. The first manifold assembly includes a first manifold body, a first plurality of common inlets formed in the first manifold body, a first plurality of outlets formed in the first manifold body, and one or more first valves disposed in the first manifold body. Each of the one or more first valves is movable between a first state and a second state, wherein in the first state, the respective first valve engages a respective first valve seat carried by the first manifold body, thereby preventing fluid from flowing from a first one of the first plurality of common inlets to the first plurality of outlets but allowing fluid to flow from a second one of the first plurality of common inlets to the first plurality of outlets, and wherein in the second state, the respective first valve is spaced from the respective first valve seat, thereby preventing fluid from flowing from the second one of the plurality of common inlets to the first plurality of outlets but allowing fluid to flow from the first one of the plurality of common inlets to the first plurality of outlets. The first manifold assembly also includes a first flow manipulation gasket arranged within the first manifold body, the flow manipulation gasket including a first gasket body configured to engage the first manifold body and one or more first flow apertures formed in the first gasket body, the one or more first flow apertures arranged in a first pre-determined pattern so as to route fluid flowing to the plurality of outlets along one or more desired/pre-determined flow paths. The second manifold assembly includes a second manifold body, a second plurality of common inlets formed in the second manifold body, a second plurality of outlets formed in the second manifold body, and one or more second valves disposed in the second manifold body. Each of the one or more second valves is movable between a first state and a second state, wherein in the first state, the respective second valve engages a respective second valve seat carried by the second manifold body, thereby preventing fluid from flowing from a first one of the second plurality of common inlets to the second plurality of outlets but allowing fluid to flow from a second one of the second plurality of common inlets to the second plurality of outlets, and wherein in the second state, the respective second valve is spaced from the respective second valve seat, thereby preventing fluid from flowing from the second one of the second plurality of common inlets to the second plurality of outlets but allowing fluid to flow from the first one of the second plurality of common inlets to the second plurality of outlets. The second manifold assembly also includes a second flow manipulation gasket arranged within the second manifold body, the flow manipulation gasket including a second gasket body configured to engage the second manifold body and one or more second flow apertures formed in the second gasket body, the one or more second flow apertures arranged in a second pre-determined pattern so as to route fluid flowing to the plurality of outlets along one or more desired/pre-determined flow paths.

In accordance with a third exemplary aspect of the present disclosure, a method of manufacturing a modular manifold assembly for use with a microfluidic chip is provided. The method includes providing a manifold body including one or more valve seats, a first common inlet, a second common inlet, and plurality of outlets, disposing one or more valves in the manifold body, each of the one or more valves movable between a first state and a second state, wherein in the first state, the respective valve engages a respective valve seat of the one or more valve seats, thereby preventing fluid from flowing from the first common manifold inlet to the plurality of outlets but allowing fluid to flow from the second common manifold inlet to the plurality of outlets and, and wherein in the second state, the respective valve is spaced from the respective valve seat of the one or more valve seats, thereby allowing fluid to flow from the first common manifold inlet to the plurality of outlets but preventing fluid from flowing from the second common manifold inlet to the plurality of outlets, forming a first flow manipulation gasket including a first gasket body and one or more first flow apertures formed in the first gasket body, the one or more first flow apertures arranged in a first pre-determined manner so as to route fluid flowing to the plurality of outlets along one or more first desired/pre-determined flow paths, arranging the flow manipulation gasket within the manifold body and adjacent the one or more valves, removing the first flow manipulation gasket from the manifold body, forming a second flow manipulation gasket including a second gasket body and one or more second flow apertures formed in the second gasket body, the one or more second flow apertures arranged in a second pre-determined manner so as to route fluid flowing to the plurality of outlets along one or more second desired/pre-determined flow paths, and arranging the second flow manipulation gasket within the manifold body and adjacent the one or more valves.

In accordance with a fourth exemplary aspect of the present disclosure, a manifold assembly is provided. The manifold assembly includes an interface layer including an interface plate, the interface plate defining a first channel and a second channel separated from one another, the interface plate including a plurality of spaced apart energy directors disposed between the first channel and the second channel. The interface layer also includes a first pressure inlet in flow communication with the first channel, and a second pressure inlet in flow communication with the second channel, and a plurality of exit apertures, each of the exit apertures extending through the interface layer and being aligned with a corresponding one of the energy directors carried by the path plate. The manifold assembly also includes a flow manipulation gasket sized for placement adjacent the interface plate and arranged to cover the first channel and the second channel thereby defining a first flow path at a first pressure and a second flow path at a second pressure. The flow manipulation gasket includes a plurality of configurable areas, each of the configurable areas disposed adjacent a corresponding one of the energy directors. Each of the configurable areas of the gasket is provided with a selected one of: a first aperture spanning the energy director and the first channel thereby providing flow communication between the first channel, the energy director, and an adjacent one of the exit apertures; a second aperture spanning the energy director and the second channel thereby providing flow communication between the second channel, the energy director, and the adjacent one of the exit apertures; and no aperture, thereby preventing flow between the first channel and the second channel and the adjacent one of the exit apertures.

In accordance with a fifth exemplary aspect of the present disclosure, a manifold assembly is provided. The manifold assembly includes a valve seat layer disposed adjacent an inlet side of the manifold assembly, the valve seat layer having a plurality of first inlet apertures, each of the first inlet apertures extending through the valve seat layer, the outlet side of the valve seat layer defining a first series of channels and a second series of channels, the first series of channels separated from the second series of channels. The manifold assembly includes a first pressure inlet in flow communication with the first series of channels, a plurality of spaced apart energy directors disposed between the first series of channels and the second series of channels, each of the energy directors being positioned adjacent to a downstream end of a corresponding one of the inlet apertures, a flow manipulation gasket sized for placement adjacent the outlet side of the valve seat layer and arranged to cover the first series of channels and the second series of channels thereby defining a first series of flow paths and a second series of flow paths, and an end cap secured to the valve seat layer and retaining the flow manipulation gasket between the end cap and the valve seat layer. The flow manipulation gasket includes a plurality of configurable areas, each of the configurable areas disposed adjacent a corresponding one of the energy directors. Each of the configurable areas of the gasket is provided with either: an aperture spanning the corresponding one of the energy directors and a selected one of the first series of flow paths; or no aperture, thereby preventing flow between the corresponding one of the energy directors and the first series of flow paths. An inlet side of the valve seat layer includes a plurality of second inlet apertures adjacent the plurality of first inlet apertures, respectively, the inlet side of the valve seat layer defining a flow path between each of the first inlet apertures and an adjacent second inlet aperture.

In accordance with a sixth exemplary aspect of the present disclosure, a manifold assembly is provided. The manifold assembly includes a valve seat layer disposed adjacent an inlet side of the manifold assembly, the valve seat layer having a plurality of first inlet apertures, each of the first inlet apertures extending through the valve seat layer, the outlet side of the valve seat layer defining a first series of channels and a second series of channels, the first series of channels separated from the second series of channels. The manifold assembly also includes a first pressure inlet in flow communication with the first series of channels, a plurality of spaced apart energy directors disposed between the first series of channels and the second series of channels, each of the energy directors being positioned adjacent to a downstream end of a corresponding one of the inlet apertures, and a flow manipulation gasket sized for placement adjacent the outlet side of the valve seat layer and arranged to cover the first series of channels and the second series of channels thereby defining a first series of flow paths and a second series of flow paths. The flow manipulation gasket includes a plurality of configurable areas, each of the configurable areas disposed adjacent a corresponding one of the energy directors. Each of the configurable areas of the gasket is provided with either: an aperture spanning the corresponding one of the energy directors and a selected one of the first series of flow paths; or no aperture, thereby preventing flow between the corresponding one of the energy directors and the first series of flow paths. An inlet side of the valve seat layer includes a plurality of second inlet apertures adjacent the plurality of first inlet apertures, respectively, the inlet side of the valve seat layer defining a flow path between each of the first inlet apertures and an adjacent second inlet aperture.

In further accordance with any one or more of the foregoing first, second, or third exemplary aspects, a modular manifold assembly, a modular manifold, a method of manufacturing a modular manifold assembly, or a manifold assembly may include any one or more of the following preferred forms.

In one preferred form, the manifold body includes an interface layer and a valve seat layer coupled to the interface layer, the valve seat layer defining the one or more valve seats.

In another preferred form, the valve seat layer has a first side, a second side opposite the first side, and one or more through apertures extending between the first side and the second side, the first side including the one or more valve seats, and the second side including a plurality of outlet channels fluidly connecting the one or more through apertures and the plurality of outlets.

In another preferred form, wherein the manifold body includes an interface plate, wherein the interface plate includes a plurality of inlet channels connecting the first and second common manifold inlets and an upstream end of the one or more valves.

In another preferred form, the interface plate is disposed in the interface layer.

In another preferred form, the manifold body further includes an end layer coupled to the valve seat layer.

In another preferred form, the flow manipulation gasket is arranged between the valve seat layer and the end layer.

In another preferred form, the flow manipulation gasket is carried by the interface layer.

In another preferred form, the flow manipulation gasket is arranged between a portion of the interface layer and the interface plate.

In another preferred form, a second manipulation gasket is arranged within the manifold body and adjacent the one or more valves. The second manipulation gasket includes a second gasket body configured to engage the manifold body and a plurality of configurable areas formed in the second gasket body, the plurality of configurable areas of the second manipulation gasket configured to route fluid flowing to the plurality of outlets along one or more desired/pre-determined second flow paths, the one or more desired/pre-determined section flow paths being different from the one or more desired/pre-determined first flow paths.

In another preferred form, the plurality of outlets are formed in the valve seat layer.

In another preferred form, the second common manifold inlet is formed in the interface layer.

In another preferred form, a third common manifold inlet is formed in the manifold body, wherein when the respective valve is in the first state, fluid is allowed to flow from the second common manifold inlet or the third common manifold inlet to the plurality of outlets, and wherein when the respective valve is in the second state, fluid is prevented from flowing from the third common manifold inlet to the plurality of outlets

In another preferred form, the third common inlet is formed in the interface layer.

In another preferred form, each of the one or more valves is a solenoid valve, wherein in the first state, the solenoid valve is de-energized, and wherein responsive to energization of the solenoid valve, the solenoid valve moves from the first state to the second state.

In another preferred form, the flow manipulation gasket is arranged downstream of the one or more valves.

In another preferred form, the flow manipulation gasket is arranged upstream of the one or more valves.

In another preferred form, the flow manipulation gasket is arranged immediately adjacent the valve seat layer.

In another preferred form, the flow manipulation gasket is removable and replaceable with a second flow manipulation gasket having a second plurality of configurable areas different from the plurality of configurable areas.

In another preferred form, each of the first and second manifold bodies includes an interface layer and a valve seat layer coupled to the interface layer, the valve seat layer defining the one or more valve seats.

In another preferred form, each of the first and second manifold bodies includes an interface plate, wherein the interface plate includes a plurality of inlet channels connecting the first and second common manifold inlets and an upstream end of the one or more valves.

In another preferred form, each of the first and second manifold bodies further includes an end layer coupled to the valve seat layer.

In another preferred form, the first flow manipulation gasket is arranged between the valve seat layer and the end layer of the first manifold body.

In another preferred form, the first flow manipulation gasket is carried by the interface layer of the first manifold body.

In another preferred form, the first flow manipulation gasket is arranged between a portion of the interface layer and the interface plate of the first manifold body.

In another preferred form, the second pre-determined pattern is different from the first pre-determined pattern.

In another preferred form, the first plurality of outlets are formed in the valve seat layer of the first manifold body and the second plurality of outlets are formed in the valve seat layer of the second manifold body.

In another preferred form, the first plurality of common inlets are formed in the interface layer of the first manifold body.

In another preferred form, each of the one or more first valves and the one or more second valves is a solenoid valve, wherein in the first state, the respective solenoid valve is de-energized, and wherein responsive to energization of the respective solenoid valve, the respective solenoid valve moves from the first state to the second state.

In another preferred form, the first flow manipulation gasket is removable and replaceable with a third flow manipulation gasket having one or more third flow apertures arranged in a second-predetermined manner different from the first pre-determined manner.

In another preferred form, the flow manipulation gasket is removable without removing the one or more valves from the manifold body.

In another preferred form, the first and second flow manipulation gaskets are formed using an additive manufacturing technique.

In another preferred form, the manifold body is formed using an additive manufacturing technique.

In another preferred form, the interface layer includes an exit side, each of the exit apertures adjacent the exit side being arranged to receive a solenoid valve.

In another preferred form, the flow manipulation gasket includes a plurality of alignment apertures, and wherein the interface plate includes alignment bosses positioned to engage the alignment apertures of the flow manipulation gasket.

In another preferred form, the interface layer and the flow manipulation gasket are secured to another by threaded fasteners.

In another preferred form, the inlet side of the manifold assembly includes a plurality of valve seats, each of the valve seats arranged to receive a solenoid valve, and including one or more valves each disposed in a corresponding valve seat, each of the one or more valves movable between a first state and a second state, wherein in the first state, the respective valve is seated against its corresponding valve seat thereby preventing fluid flow from a corresponding first inlet aperture to the plurality of outlets and preventing fluid from flowing from the first common manifold inlet to the plurality of outlets, and wherein in the second state, the respective valve engages the respective valve seat of the one or more valve seats, thereby allowing fluid to flow from the first common manifold inlet to the plurality of outlets but preventing fluid from flowing from the second common manifold inlet to the plurality of outlets.

In another preferred form, each of the one or more valves is a solenoid valve.

In another preferred form, the inlet side of the valve seat layer is arranged to receive a solenoid valve adjacent to each of the inlet apertures.

In another preferred form, the flow manipulation gasket includes a plurality of alignment apertures, and wherein the end cap includes alignment bosses positioned to engage the alignment apertures of the flow manipulation gasket.

In another preferred form, the inlet side of the manifold assembly includes a plurality of valve seats, each of the valve seats arranged to receive a solenoid valve, and including one or more valves each disposed in a corresponding valve seat, each of the one or more valves movable between a first state and a second state, wherein in the first state, the respective valve is seated against its corresponding valve seat thereby preventing fluid flow from a corresponding first inlet aperture to the plurality of outlets and preventing fluid from flowing from the first common manifold inlet to the plurality of outlets, and wherein in the second state, the respective valve engages the respective valve seat of the one or more valve seats, thereby allowing fluid to flow from the first common manifold inlet to the plurality of outlets but preventing fluid from flowing from the second common manifold inlet to the plurality of outlets.

### BRIEF DESCRIPTION OF THE DRAWINGS

FIG. 1 is a perspective view of one example of a modular manifold constructed in accordance with the teachings of the present disclosure, the modular manifold including first (or left) and second (or right) manifold assemblies coupled together.

FIG. 2 is similar to FIG. 1, but with the valve seat and interface layers of the first manifold body of the first manifold assembly depicted transparently and an end cap of the first modular manifold assembly removed.

FIG. 3 is a front perspective view of the end cap of the first manifold assembly.

FIG. 4 is a rear perspective view of the end cap of FIG. 3.

FIG. 5 is an exploded view of various components of the first manifold assembly, specifically an outer flow manipulation gasket, the valve seat layer, an inner flow manipulation gasket, and an interface plate.

FIG. 6 is a front perspective view showing the outer flow manipulation gasket coupled to the valve seat layer.

FIG. 7 is a front perspective view showing the outer flow manipulation gasket.

FIG. 8 is a front perspective view showing the valve seat layer.

FIG. 9 is a rear perspective view of the valve seat layer of FIG. 8.

FIG. 10 is a front view of the valve seat layer of FIG. 9.

FIG. 11 is a close-up of a portion of FIG. 10.

FIG. 12 is similar to FIG. 1, but with the end cap, the outer flow manipulation gasket, and the valve seat layer of the first manifold assembly removed for clarity.

FIG. 13 is a front perspective view of one of the valves that can be utilized in the modular manifold, along with a bracket for physically connecting the respective valve to the modular manifold and electrical connectors for electrically connecting the respective valve to the modular manifold.

FIG. 14 is a side view of FIG. 13.

FIG. 15 is a top view of FIG. 13.

FIG. 16 is a front perspective view of the interface layer of the first manifold assembly.

FIG. 17 is a rear perspective view of FIG. 16, showing the inner flow manipulation gasket and the interface plate coupled to the interface layer.

FIG. 18 is similar to FIG. 17, but with the components depicted transparently.

FIG. 19 is similar to FIG. 17, but with the inner manipulation gasket and the interface plate removed from the interface layer.

FIG. 20 is a front perspective view of the inner manipulation gasket and the interface plate coupled to one another, but with the inner manipulation gasket depicted transparently.

FIG. 21 is a plan view of FIG. 20.

FIG. 22 is a front perspective view of the second manipulation gasket.

FIG. 23 is a rear perspective view of the interface plate.

FIG. 24 is a plan view of FIG. 23.

FIG. 25 is a front perspective view of the interface plate.

FIG. 26 is a front perspective view of a printed circuit board that is captured between the first and second manifold assemblies.

FIGS. 27A and 28 are partial cross-sectional views of the first manifold assembly, showing how fluid flows (or is blocked from flowing) from the first manifold inlet, the second manifold inlet, or the third manifold inlet to the plurality of manifold outlets, depending upon whether the respective valve is in the first state or the second state.

FIG. 27B illustrates the arrangement of the different valves and whether the second manifold inlet or the third manifold inlet is fluidly connected to a third port of the respective valve.

FIGS. 29A, 29B, 29C, and 30 illustrate how the inner flow manipulation gasket can be configured to manipulate fluid flow by selectively permitting or blocking flow from two (or more) pneumatic pressures to the outlets by utilizing flow apertures (or no flow aperture at all).

FIGS. 31A-31C illustrates different examples of geometries that the energy directors can used to selectively permit or block flow from two (or more) pneumatic pressures.

FIG. 32 illustrates how the outer flow manipulation gasket can be configured to manipulate fluid flow by selectively permitting or blocking flow from the common inlets to the outlets.

FIG. 33 is a perspective view of another example of a modular manifold constructed in accordance with the teachings of the present disclosure.

FIG. 34 is similar to FIG. 33 but with some of the components of the modular manifold depicted transparently.

FIG. 35 is another perspective view of the modular manifold of FIGS. 33 and 34.

FIG. 36 is a plan view of the interface plate and inner flow manipulation gasket utilized in the modular manifold of FIGS. 33-35.

FIG. 37 is a plan view of the valve seat layer of the modular manifold of FIGS. 33-36.

### DETAILED DESCRIPTION OF THE DRAWINGS

The present disclosure is directed to a modular manifold that is a multi-layered manifold assembly that includes fasteners arranged in a relatively tight pattern and is intended to replace the large array of valves (interconnected with tubing) typically needed in medical, industrial, or analytical applications, thereby reducing the footprint needed. The modular manifold assembly includes one or more flow manipulation gaskets having configurable areas that can be configured to selectively manipulate fluid flowing therethrough in a desired manner. For example, a manipulation gasket can be provided with a first aperture that permits flow from a first input (fluidly coupled to a first pneumatic pressure) and blocks flow from a second input (fluidly coupled to a second pneumatic pressure), a second aperture that blocks flow from the first input and allows flow from the second input, or no aperture at all, thereby blocking flow from both the first and second inputs. By selectively routing fluid flow in this manner, this eliminates the need for mirrored versions of molded parts, allowing for a non-symmetrical component to be used in a mirrored state without the additional tooling. At the same time, by completely blocking both pneumatic pressures, one or more receiving valves can be omitted from the assembly without the need for one or more blanking stations.

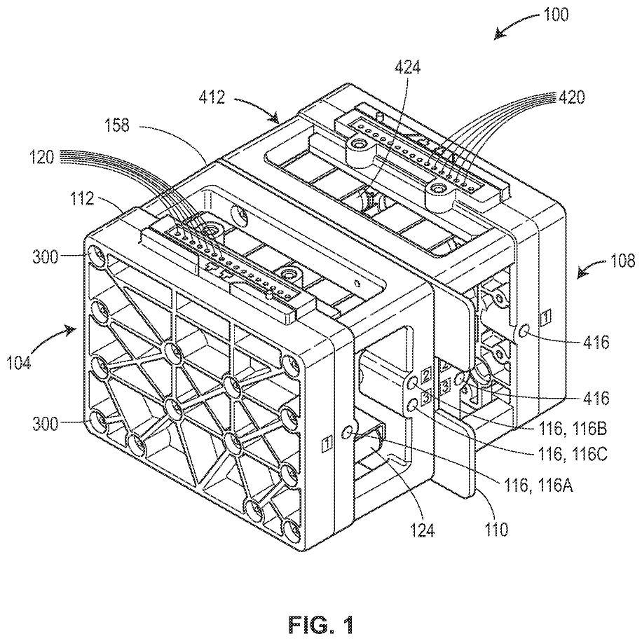

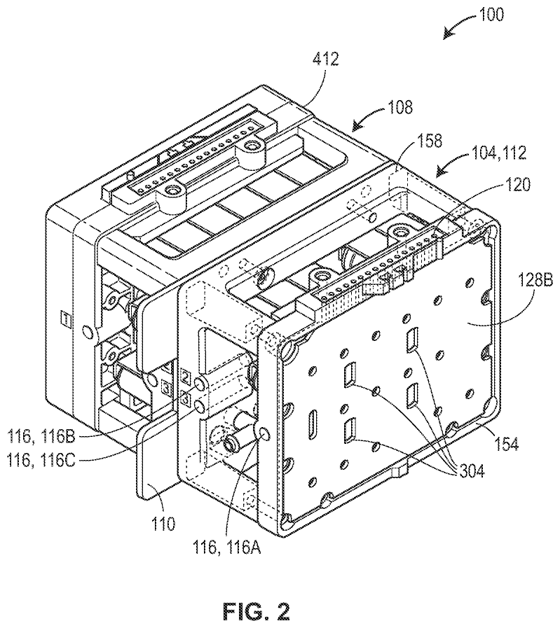

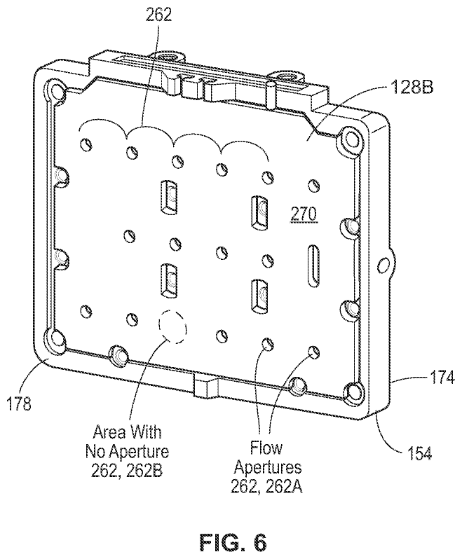

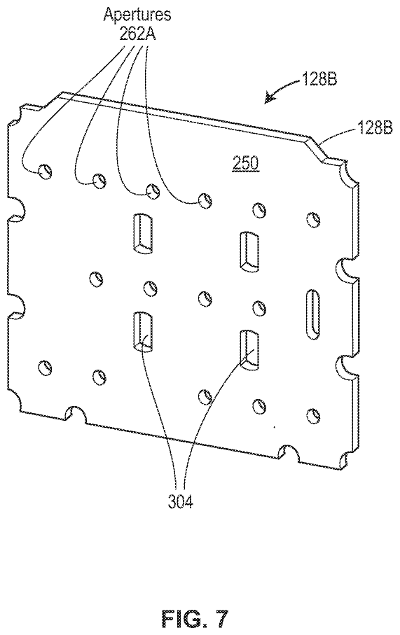

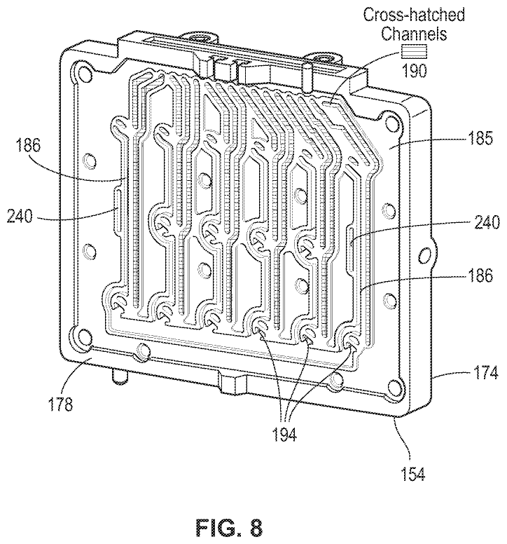

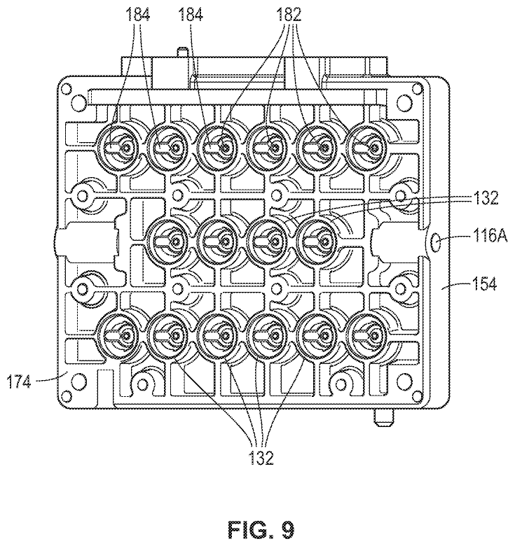

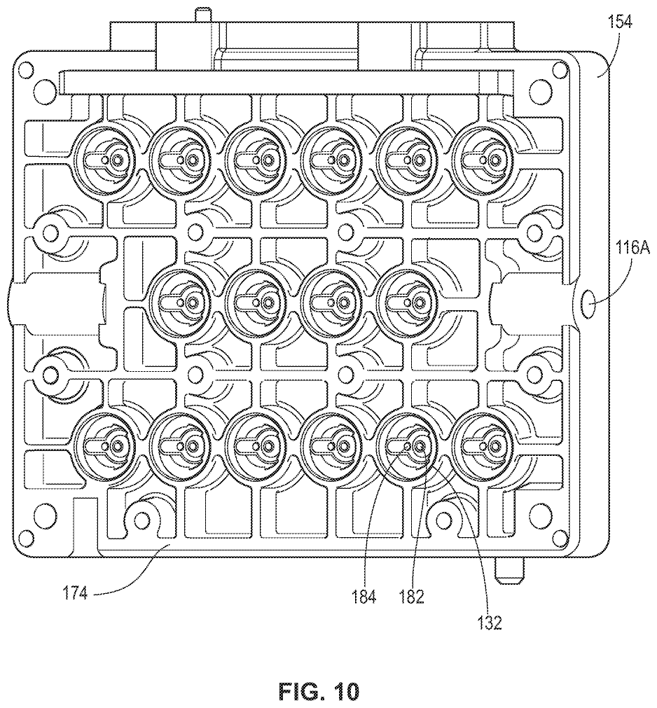

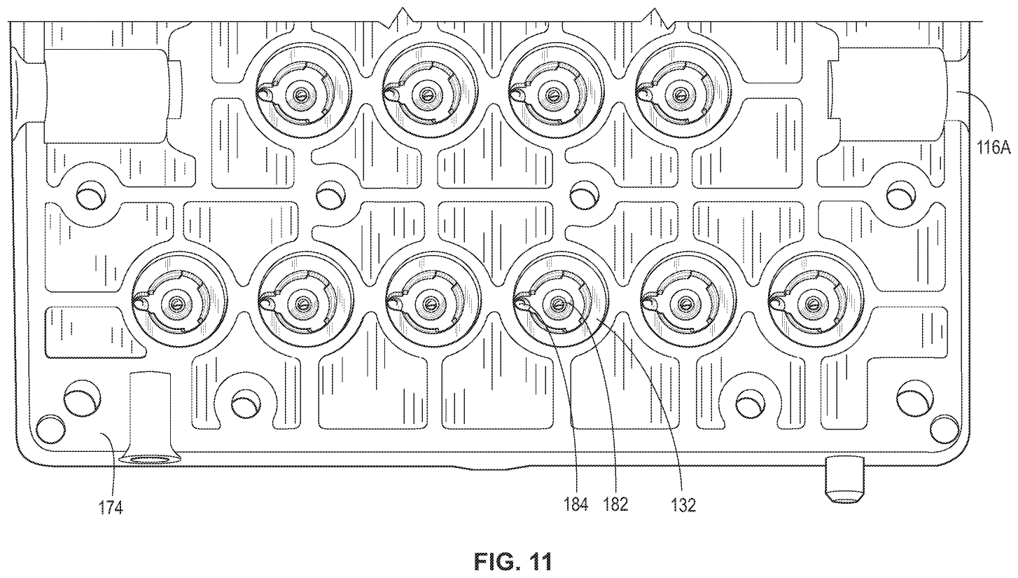

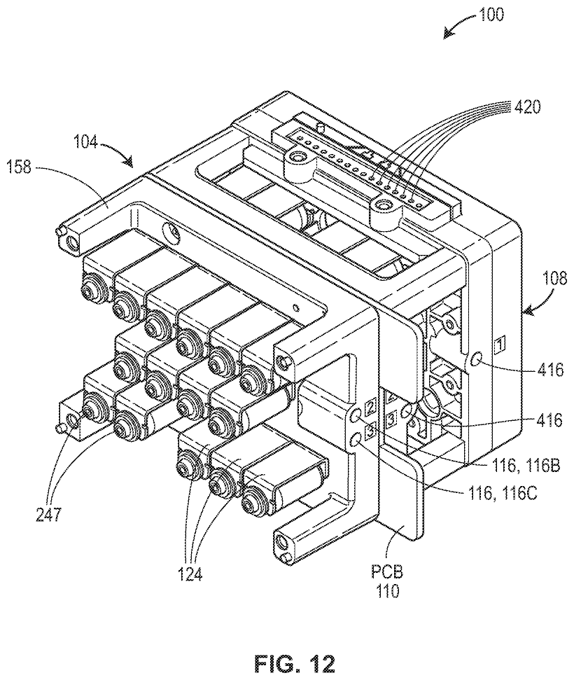

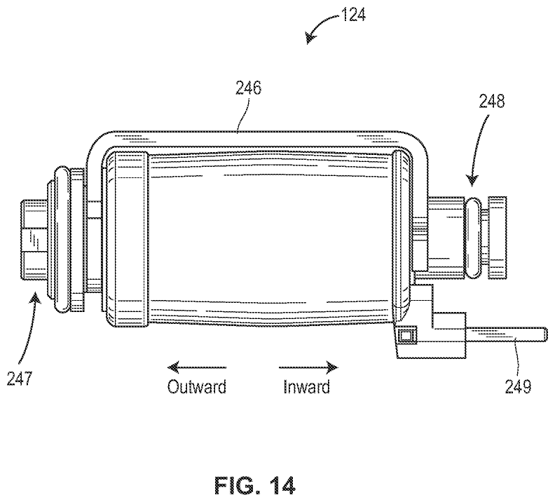

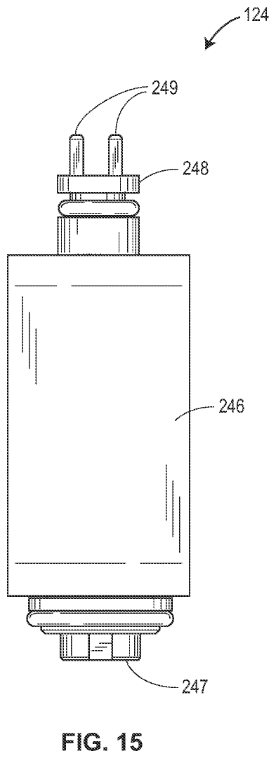

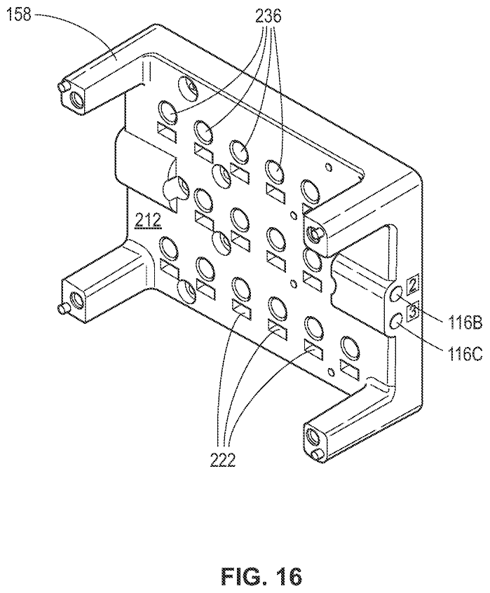

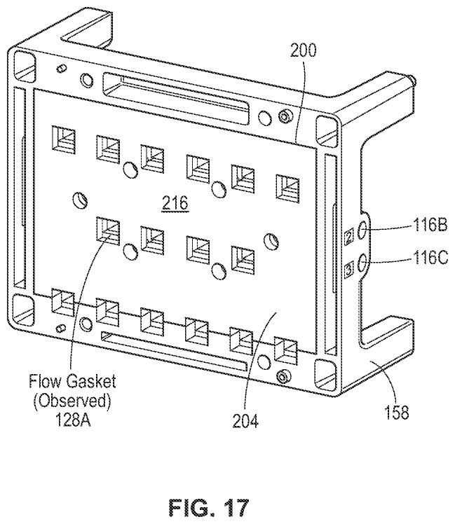

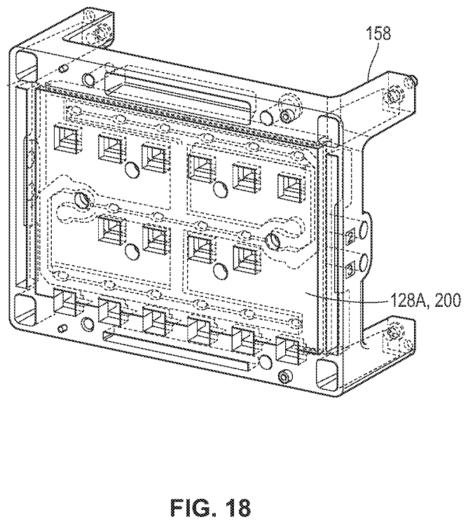

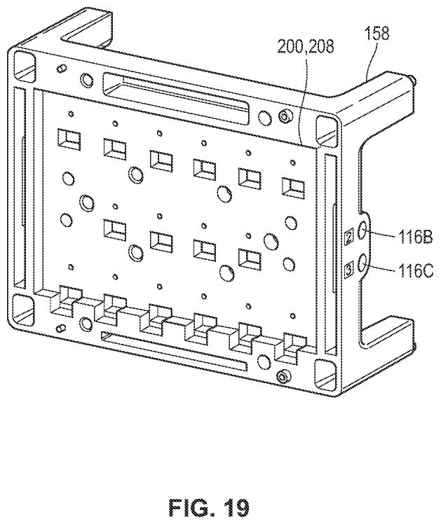

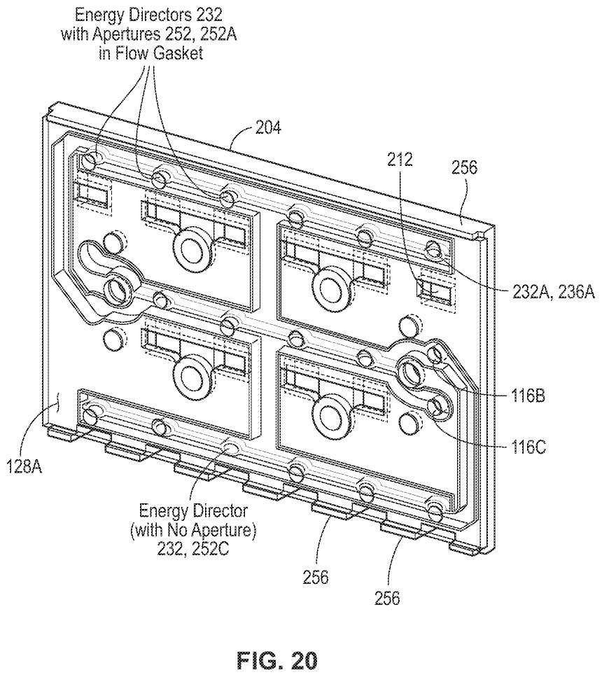

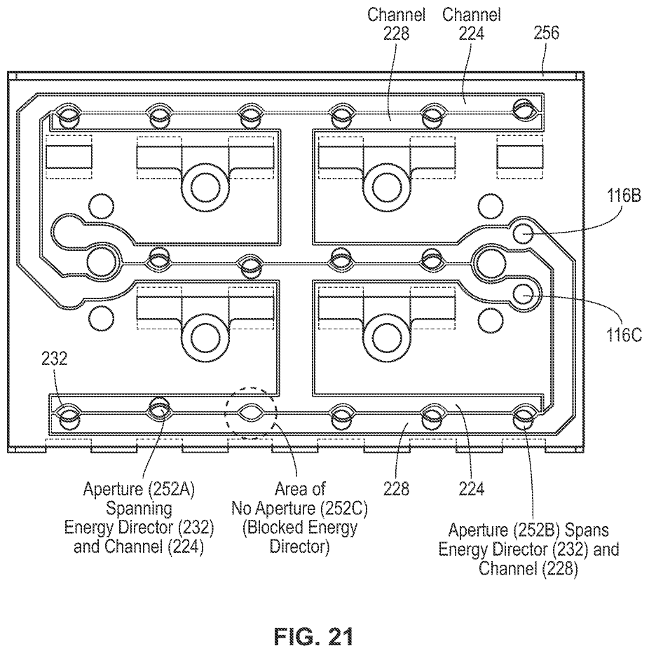

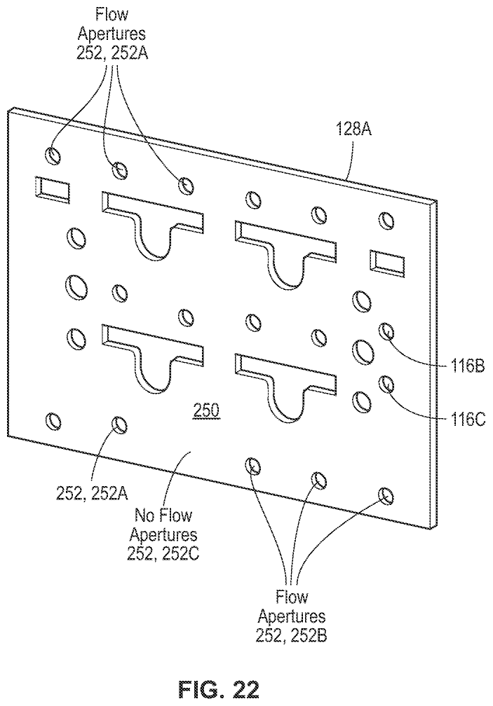

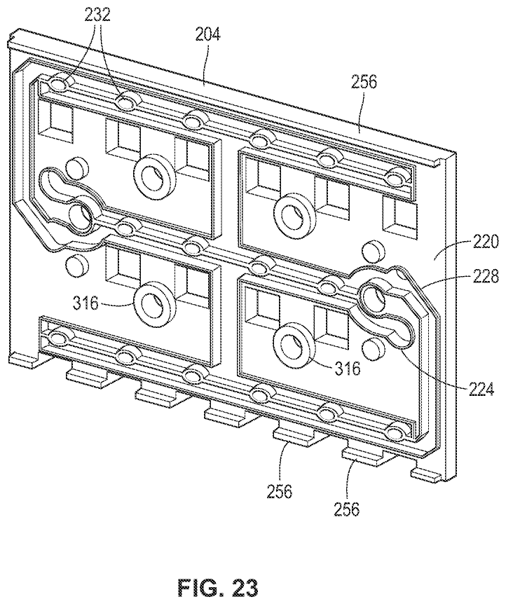

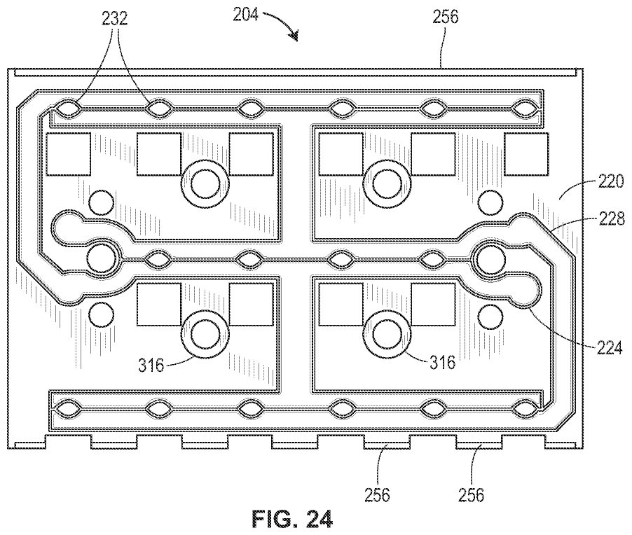

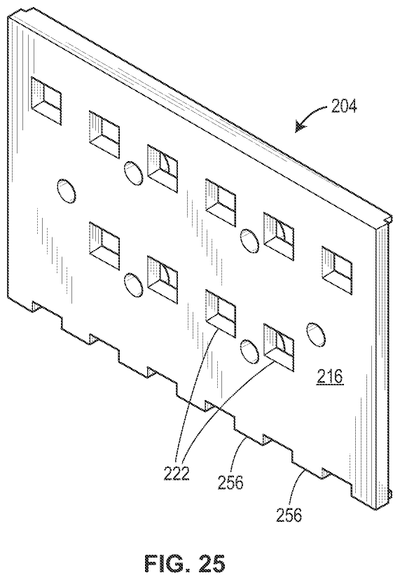

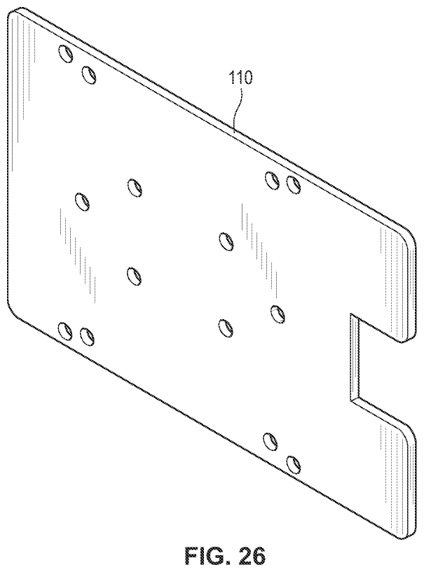

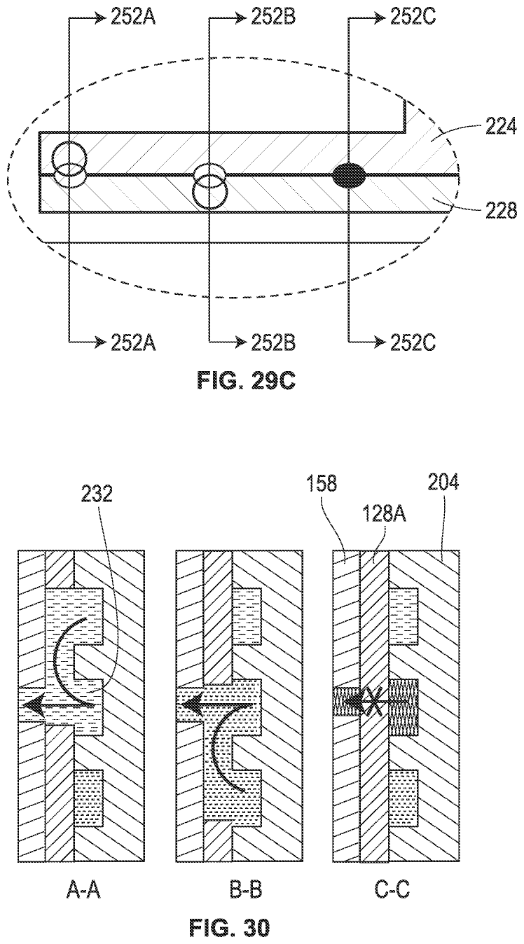

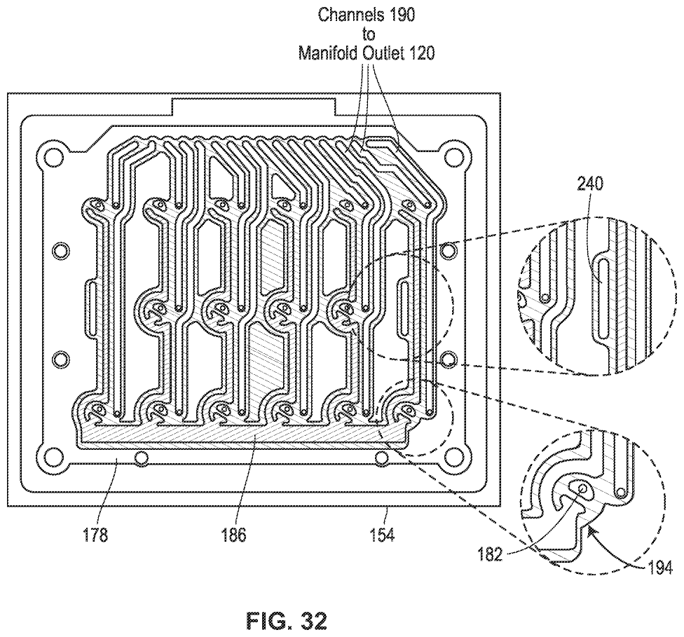

FIGS. 1-32 illustrate one example of a modular manifold 100 constructed in accordance with the teachings of the present disclosure. The modular manifold 100 is specifically configured to use positive and negative pressure to remotely pilot a microfluidic chip in a hematology unit that deals with human blood, though it will be appreciated that the modular manifold 100 can be used for other medical applications (or non-medical applications). The modular manifold 100 generally includes a first (or left) manifold assembly 104 and a second (or right) manifold assembly 108. The modular manifold 100 also generally includes a printed circuit board (“PCB”) 110 that is captured between the first and second manifold assemblies 104, 108. While not illustrated herein, it will be appreciated that the modular manifold 100 may also include or be coupled to the microfluidic chip, pressure tanks connected to the modular manifold, and tubing that connects the tanks to the modular manifold.

The first manifold assembly 104 generally includes a first manifold body 112, a first plurality of common inlets 116 formed in the first manifold body 112, a first plurality of outlets 120 formed in the first manifold body 112, a plurality of first valves 124 disposed in the first manifold body 112, and one or more first flow manipulation gaskets 128 arranged within the first manifold body 112 and adjacent the plurality of first valves 124. Each of the first valves 124 is movable between a first position (or state) and a second position (or state) to selectively permit fluid flow through the first manifold assembly 104. In the first position, the respective first valve 124 engages a respective first valve seat 132 carried by the first manifold body 112, thereby preventing fluid from flowing from a first one of the first plurality of common inlets 116 to the first plurality of outlets 120 but allowing fluid to flow from a second one of the first plurality of common inlets 116 to the first plurality of outlets 120. Meanwhile, in the second position, the respective first valve 124 is spaced from the respective first valve seat 132, thereby preventing fluid from flowing from the second one of the plurality of common inlets 116 to the first plurality of outlets 120 but allowing fluid to flow from the first one of the plurality of common inlets 116 to the first plurality of outlets 120. Further details regarding the first valves 124 will be discussed below. The one or more first flow manipulation gaskets 128 can be arranged downstream and/or upstream of the plurality of valves 124 to manipulate the flow of fluid as desired. Each first flow manipulation gasket 128 generally includes a gasket body configured to matingly engage one or more adjacent components of the first manifold assembly 104 in the first manifold body 112, and the gasket body includes a plurality of configurable areas that route fluid flowing to the first plurality of outlets 120 in a desired or pre-determined manner. Each of the configurable areas can be “configured”, or provided, with (i) a flow aperture located, sized, and shaped so as to permit fluid flow therethrough in a desired direction, or (ii) no aperture, such that the gasket body prevents fluid flow therethrough.

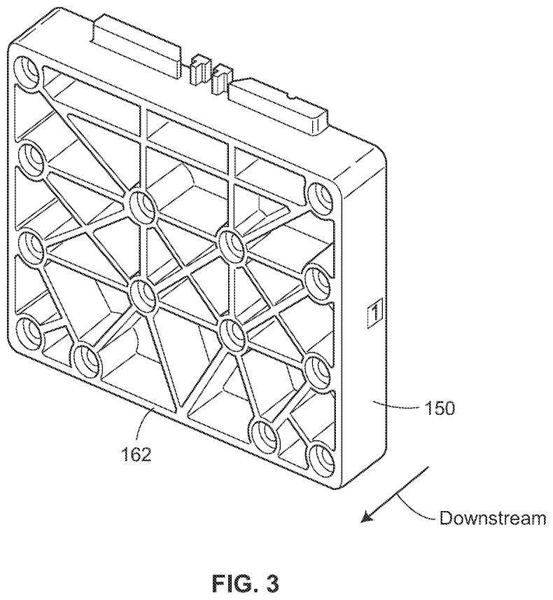

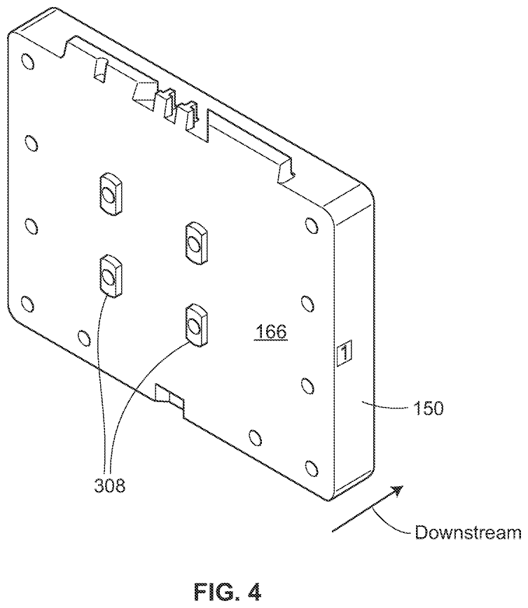

The first manifold body 112 generally includes a plurality of different layers coupled together. In this example, the first manifold body 112 generally includes three different layers—an end layer 150, a valve seat layer 154, and an interface layer 158. The end layer 150 generally defines the first end of the first manifold body 112. As best illustrated in FIGS. 3 and 4, the end layer 150 takes the form of an end cap having a substantially rectangular three-dimensional shape defined by a first (or upstream) side 162 and a second (or downstream) side 166 that is opposite the first side 162 and is exposed to the environment surrounding the manifold 100. The valve seat layer 154 is disposed between the end layer 150 and the interface layer 158 and generally defines the plurality of valve seats 132 for the plurality of first valves 124, respectively, such that the manifold 100 can accommodate the plurality of first valves 124. In other examples, however, the valve seat layer 154 may only define a single valve seat 132 for a single first valve 124.

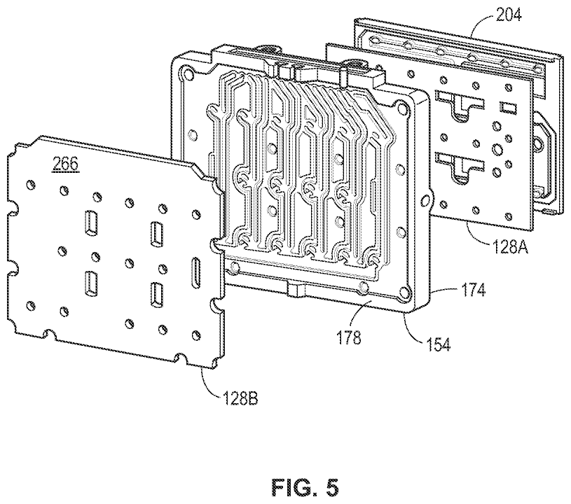

As illustrated in FIGS. 5, 6, and 8-11, the valve seat layer 154 also has a substantially rectangular three-dimensional shape defined by a first (or inlet) side 174 and a second (or outlet) side 178 opposite the first side 174. The plurality of valve seats 132 extend outward from the first side 174. The valve seat layer 154 includes a plurality of first inlet apertures 182 positioned immediately adjacent the plurality of valve seats 132, respectively (and, in turn, a downstream end of the plurality of valves 124). The plurality of first inlet apertures 182 extend through the valve seat layer 154, from the first side 174 to the second side 178. The valve seat layer 154 also includes a plurality of second inlet apertures 184 disposed on the first side 174 and positioned immediately adjacent the plurality of first inlet apertures 182, respectively. The first side 174 also defines a flow path between each of the plurality of first inlet apertures 182 and an adjacent second inlet aperture 184 of the plurality of second inlet apertures. Because the first inlet apertures 182 and the second inlet apertures 184 are positioned immediately adjacent the downstream end of the plurality of valves 124, respectively, the plurality of first inlet apertures 182 may also be referred to herein as the plurality of first valve ports, respectively, and the plurality of second inlet apertures 184 may also be referred to herein as the plurality of second valve ports, respectively.

Meanwhile, the second side 178 faces the end layer 150 and has a recessed area 185 that includes or defines a first series of outlet channels 186 and a second series of outlet channels 190 separated from the first series of outlet channels 186. The recessed area 185 of the second side 178 also includes a plurality of first spaced apart energy directors 194 disposed between the first series of outlet channels 186 and the second series of outlet channels 190, respectively. In this example, each of the energy directors 194 takes the form of a sharp raised edge that depress into the gasket body of an adjacent first flow manipulation gasket 128. In any event, each of the energy directors 194 is positioned adjacent to a downstream end of a corresponding one of the plurality of first inlet apertures 182. For example, energy director 194A is positioned adjacent to a downstream end of first inlet aperture 182A.

As best illustrated in 1, 2, and 12, the interface layer 158 is disposed between the valve seat layer 154 and the PCB 110. The interface layer 158 generally includes a recessed area 196 and an interface plate 204 disposed in the recessed area 200. Like the valve seat layer 154, the interface layer 158 also has a substantially rectangular three-dimensional shape defined by a first (or inlet) side 208 and a second (or outlet) side 212 opposite the first side 208. The first side 208 faces the PCB 110, whereas the second side 212 faces the valve seat layer 154. The first side 208 includes the recessed area 200 (and, in turn, the interface plate 204 disposed therein).

The interface plate 204 has a first (or inlet) side 216 and a second (or outlet) side 220 opposite the first side 216. The interface plate 204 has a plurality of connector through holes 222 that extend therethrough from the first side 216 to the second side 220 and accommodate the electrical connectors for the plurality of valves 124. The interface place 204 includes or defines two channels on the second side 220—a first channel 224 and a second channel 228 separated from the first channel 224. Each of the first and second channels 224 and 228 has a travel path that substantially spans the entire length and width of the interface plate 204. The interface plate 204 also includes a plurality of spaced apart energy directors 232 disposed between the first channel 224 and the second channel 228. In this example, each of the energy directors 232 takes the form of a sharp raised edge that depress into the gasket body of an adjacent first flow manipulation gasket 128.

The interface layer 158 further includes a plurality of exit apertures 236 formed in the second side 212 of the interface layer 158. The exit apertures 236 extend through the second side 212 and are aligned with a corresponding one of the energy directors 232 carried by the interface plate 204. For example, exit aperture 236A is aligned with energy director 232A carried by the interface plate 204. The plurality of exit apertures 236 are also positioned immediately adjacent an upstream end of the valves 124.

In this example, the first manifold assembly 104 includes three common inlets 116A, 116B, 116C. The first common inlet 116A is formed in the valve seat layer 154 at a position between the first and second sides 174, 178. In this example, the first common inlet 116A is fluidly coupled to a source of vacuum pressure that supplies vacuum pressure to the first manifold assembly 104. Meanwhile, the second and third common inlets 116B, 116C are formed in the interface layer 158 such that the second and third common inlets 116 are immediately adjacent one another. In this example, each of the second and third common inlets 116B, 116C is fluidly coupled to a source of positive pressure that supplies positive pressure to the first manifold. The positive pressure fluidly coupled to the second common inlet 116B can be greater or less than the positive pressure fluidly coupled to the third common inlet 116C. In other examples, however, the first manifold assembly 104 can include more or less common inlets and/or the common inlets can be positioned elsewhere. For example, the first manifold assembly 104 can include more than two common inlets, each fluidly coupled to a source of positive pressure, as the modular manifold 100 can be adjusted to achieve a more complex manifold than the manifold illustrated in FIGS. 1-32. As another example, the common inlets can be positioned on the bottom of the manifold 100 and interface directly with the pressure tanks.

In this example, the first manifold assembly 104 includes sixteen common outlets 120. The sixteen common outlets 120 are arranged in an array formed on a top side of the valve seat layer 154, such that the sixteen common outlets 120 can be easily and quickly fluidly coupled to a microfluidics chip (or another device containing fluid). In other examples, however, the first manifold assembly 104 can include more or less common outlets 120 and/or the common outlets 120 can be positioned elsewhere.

It will be appreciated that the first common inlet 116A extends into the valve seat layer 154 and is in fluid communication with the first series of outlet channels 186 on the second side 178 of the valve seat layer 154 via one or more inlet portions 240. The first series of outlet channels 186 are in selective fluid communication with the first inlet apertures 182, respectively. When the first outlet channels 186 are in fluid communication with the first inlet apertures 182, respectively, the first common inlet 116 is in in turn in fluid communication with one or more of those first inlet apertures 182.

Meanwhile, it will be appreciated that each of the second and third common inlets 116B, 116C extends into the interface layer 158. As will be discussed in greater detail below, the second and third common inlets 116B, 116C are in selective fluid communication with the second series of outlet channels 190 on the second side 178 of the valve seat layer 154. The second common inlet 116B is in direct fluid communication with the first channel 224 of the interface plate 204, which is in turn selectively fluidly connected to one or more of the exit apertures 236 via one or more of the energy directors 232, respectively. The exit apertures 236 are in fluid communication with the second inlet apertures 184. Thus, when the first channel 224 is fluidly connected to the one or more exit apertures 236, the first channel 224 is in fluid communication with one or more of the second inlet apertures 184 (and, thus, an upstream end of one or more first valves 124, respectively). The one or more second inlet apertures 184 are in turn selectively fluidly connected to one or more of the second series outlet channels 190 via one or more first inlet apertures 182 adjacent to the one or more second inlet apertures 184 and one or more of the energy directors 194. The third common inlet 116C is in direct fluid communication with the second channel 228 of the interface plate 204, which is in turn selectively fluidly connected to one or more of the exit apertures 236 via one or more of the energy directors 232, respectively. Thus, when the second channel 228 is fluidly connected to the one or more exit apertures 236, the second channel 228 is in fluid communication with one or more of the second inlet apertures 184 (and, thus, the upstream end of one or more first valves 124, respectively). The one or more second inlet apertures 184 are in turn selectively fluidly connected to one or more of the second series outlet channels 190 via one or more first inlet apertures 182 adjacent to the one or more second inlet apertures 184 and one or more of the energy directors 194.

Further, it will be appreciated that each of the common outlets 120 extends into the valve seat layer 154. More particularly, each of the common outlets 120 extends into the valve seat layer 154 such that the common outlets 120 are in fluid communication with a respective one of the second series of outlet channels 190.

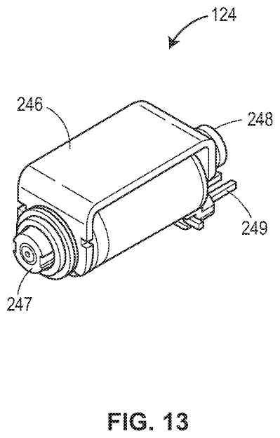

The plurality of first valves 124 generally control the fluid communication between the different components of the first manifold assembly 104. In this example, the valve seat layer 154 defines sixteen different first valve seats 132, such that the first manifold assembly 124 can include anywhere between one and sixteen different first valves 124. In this example, each of the valves 124 is a solenoid valve, one example of which is illustrated in FIGS. 13-15 and the details and operation of which are known. In other examples, however, the valve seat layer 154 can define a different number of first valve seats 132 (and, thus, a different number of first valves 124). In other examples, the valves 124 can be a different type of valve (e.g., a cartridge valve). As also illustrated in FIGS. 13-15, each of the valves 124 can be mechanically coupled to the first manifold assembly 104 via a bracket 246 such that a first (or outlet) end 247 of the valve 124 is coupled to the valve seat layer 154 and a second (or inlet) end 248 of the valve 124 is coupled to the interface layer 158. Further, each of the valves 124 can be electrically coupled to the PCB 110 via an electrical connector 249 that passes through the plurality of connector through holes 222 formed in the interface plate 204, such that the PCB 110 can in turn control the state of the plurality of valves 124.

In this example, the first manifold assembly 104 includes two first flow manipulation gaskets, flow manipulation gaskets 128A, 128B. Each of the first flow manipulation gaskets 128A, 128B is generally of sufficient and uniform thickness so as to form a geometry that controls the third dimension of an intended flow path. The first flow manipulation gaskets 128A, 128B may be cut (e.g., by die, water jet, laser), molded, or printed via an additive manufacturing technique. In any event, the first flow manipulation gaskets 128A, 128B allow or prevent fluid to bypass an energy director (e.g., the energy director 194 or 232) by allowing or preventing the fluid from moving in the 3rd dimension. To this end, the first flow manipulation gasket 128A includes a gasket body 250 (which in this example has a substantially rectangular three-dimensional shape) and a plurality of configurable areas 252, and the first flow manipulation gasket 128B includes a gasket body 260 (which in this example also has a substantially rectangular three-dimensional shape) and a plurality of configurable areas 262. It will be appreciated, however, that the plurality of configurable areas 252 of the first flow manipulation gasket 128A may, and generally will, differ from the plurality of configurable areas 262 of the first flow manipulation gasket 128B.

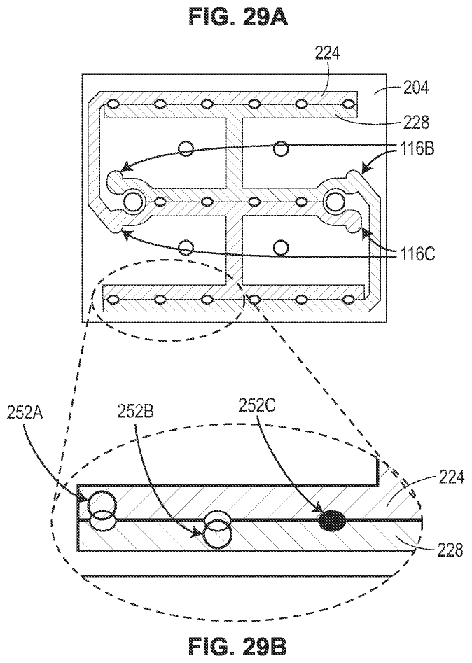

The first flow manipulation gasket 128A is generally sized for placement adjacent the interface plate 204 of the interface layer 158. In this example, the first flow manipulation gasket 128A is disposed in the recessed area 200 of the interface layer 158 such that the gasket 128A is carried by the interface layer 158 at a position upstream of the plurality of first valves 124. More particularly, the first flow manipulation gasket 128A is carried by the first side 216 of the interface plate 204 (e.g., via protrusions 256), and the first flow manipulation gasket 128A has a side that engages the first side 216 of the interface plate 204 (and, thus, engages and covers the first channel 224, the second channel 228, and the energy directors 232 disposed between the first channel 224 and the second channel 228). Even more particularly, the plurality of configurable areas 252 of the gasket 128A are disposed adjacent a corresponding one of the energy directors 232. Consistent with the discussion above, each the plurality of configurable areas 252 can be configured to manipulate fluid flow by selectively permitting or blocking flow from the second common inlet 116B and the third common inlet 116C to the common outlets 120 by utilizing a first aperture 252A, a second aperture 252B, or no aperture at all 252C (e.g., when it is necessary to omit a corresponding valve 124, which is possible without the need for a specific blanking station for that omitted valve 124). Each first aperture 252A is positioned near a top of the corresponding configurable area 252 (FIG. 29B) and spans the corresponding energy director 232 and the first channel 224, thereby fluidly connecting the first channel 224, the energy director 232, and an adjacent one of the exit apertures 236. In other words, when the configurable area 252 includes the first aperture 252A, the second common inlet 116B is in fluid communication with the corresponding second inlet aperture 184 (and, thus, can be fluidly coupled to the corresponding common outlet 120, depending upon the state of the corresponding valve 124). At the same time, the third common inlet 116C is blocked from fluid communication with the corresponding second inlet aperture 184 (and, thus, cannot be fluidly coupled to the corresponding common outlet 120, regardless of the state of the corresponding valve 124). Meanwhile, each second aperture 252B is positioned near a bottom of the corresponding configurable area 252 (FIG. 29B) and spans the corresponding energy director 232 and the second channel 228, thereby fluidly connecting the second channel 228, the energy director 232, and an adjacent one of the exit apertures 236. In other words, when the configurable area 252 includes the second aperture 252B, the third common inlet 116B is in fluid communication with the corresponding second inlet aperture 184 (and, thus, can be fluidly coupled to the corresponding common outlet 120, depending upon the state of the corresponding valve 124). At the same time, the second common inlet 116B is blocked from fluid communication with the corresponding second inlet aperture 184 (and, thus, cannot be fluidly coupled to the corresponding common outlet 120, regardless of the state of the corresponding valve 124). Finally, when the configurable area 252 includes no aperture 252C, the configurable area 252 severs the fluid connection between the first channel 224 or the second channel 228 and the adjacent exit aperture 236. In other words, when the configurable area 252 includes no aperture 252C, neither the second common inlet 116B nor the third common inlet 116C is in fluid communication with the corresponding outlet channel 190 of the second series of outlet channels 190 (and, thus, neither is in fluid communication with the corresponding common outlet 120, regardless of the state of the corresponding valve 124).

The first flow manipulation gasket 128B is generally sized for placement adjacent the valve seat layer 154. In this example, the first flow manipulation gasket 128B is disposed in the recessed area 185 of the valve seat layer 158 such that the gasket 128B is disposed between the end layer 150 and the valve seat layer 158 at a position downstream of the plurality of first valves 124. In turn, the gasket 128B has a first side 266 that engages the end layer 150 and a second side 270 that is opposite the first side 266 and engages the valve seat layer 158. More particularly, the second side 270 engages (and covers) the first series of outlet channels 186, the second series of outlet channels 190, and the energy directors 194 disposed between the first outlet channels 186 and the second outlet channels 190. Like the plurality of configurable areas 252 of the first flow manipulation gasket 128A, the plurality of configurable areas 262 can be configured to manipulate fluid flow by selectively permitting or blocking flow, but from the first common inlet 116A to the common outlets 120. Unlike the plurality of configurable areas 252 of the first flow manipulation gasket 128A, however, the plurality of configurable areas 262 of the first flow manipulation gasket 128B can be provided with either an aperture 262A or no aperture 262B. Each aperture 262A spans the corresponding energy director 194 and the corresponding channel 186 of the first series of outlet channels 186, thereby fluidly connecting the corresponding energy director 194 and the corresponding channel 186. In other words, when the configurable area 262 includes the aperture 262A, the first common inlet 116A is in fluid communication with the corresponding first inlet aperture 182 (and, thus, can be fluidly coupled to the corresponding common outlet 120, depending upon the state of the corresponding valve 124). However, when the configurable area 262 includes no aperture 262B, the configurable area 262 severs the fluid connection between the corresponding energy director 194 and the corresponding channel 186. In other words, when the configurable area 262 includes no aperture 262B, the first common inlet 116A is not in fluid communication with the corresponding first inlet aperture 182 (and, thus, is not in fluid communication with the corresponding common outlet 120, regardless of the state of the corresponding valve 124).

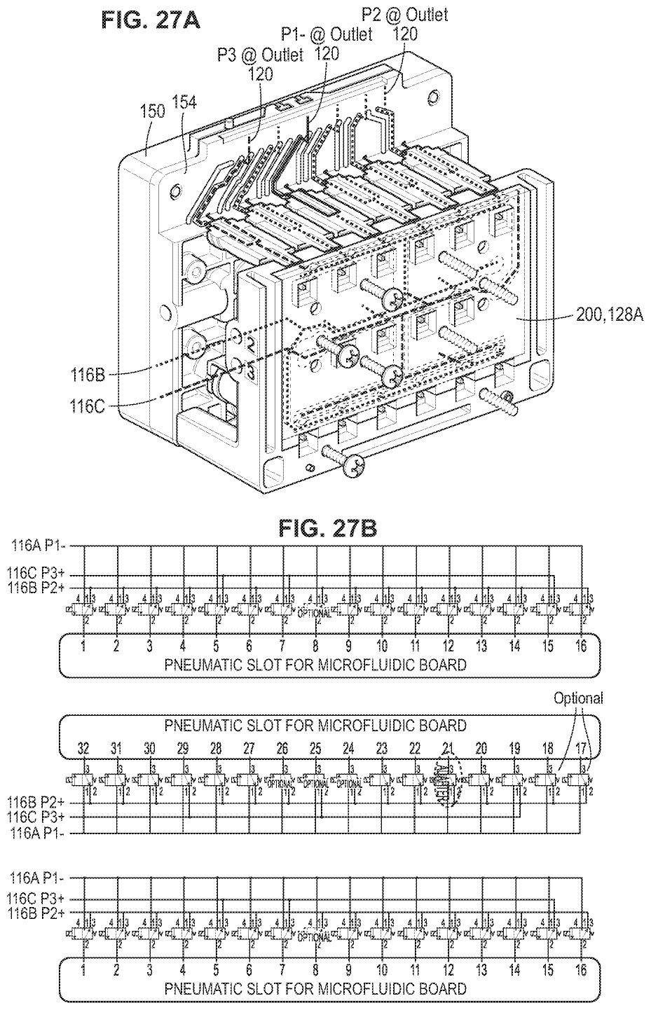

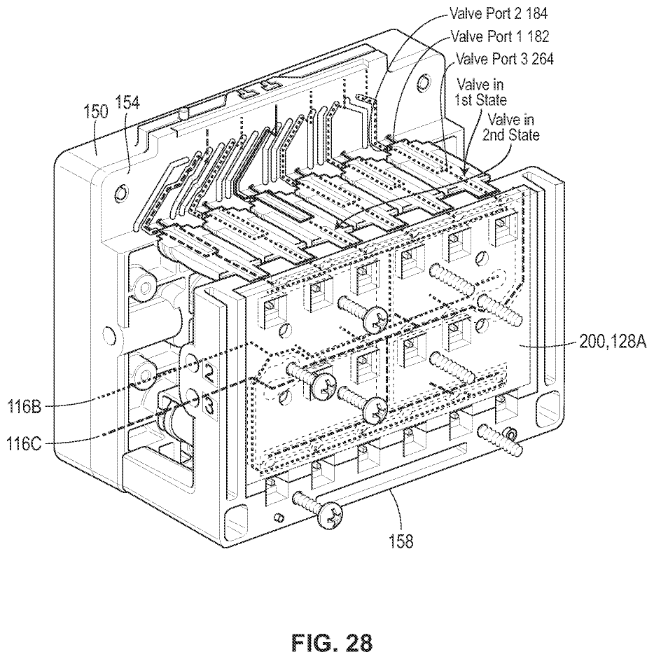

FIGS. 27A, 27B, and 28 illustrate the operation of the first manifold assembly 104. More particularly, FIGS. 27A, 27B, and 28 illustrate how fluid flows (or is blocked from flowing) from the first common manifold inlet 116A, the second common manifold inlet 116B, or the third common manifold inlet 116C to the plurality of common manifold outlets 120, depending upon whether the first common manifold inlet 116A is or is not fluidly connected to the first valve port 182 of the respective valve 124 (which will depend upon the configuration of the first flow manipulation gasket 128B), whether the second common manifold inlet 116B or the third common manifold inlet 116C is (or is not) fluidly connected to a third (internal) port 264 of the respective valve 124 (which will depend upon the configuration of the first flow manipulation gasket 128A), and whether the respective valve 124 is in the first state or the second state. For example, when the respective valve 124 is in the first state, a portion of the valve 124 (e.g., the first end 247 of the valve 124) engages a respective valve seat 132 of the plurality of valve seats 132 of the valve seat layer 154, such that the first port 182 is blocked and the second port 184 of the valve 124 is fluidly connected to the third port 264 (and, as such, the second common manifold inlet 116B or the third common manifold inlet 116C and the source of positive pressure fluidly connected thereto). In turn, fluid is allowed to flow from the second common manifold inlet 116B or the third common manifold inlet 116C (depending upon which inlet is connected to the respective third port 264, as dictated by the first flow manipulation gasket 128A) to the plurality of outlets 120 via the second port 184 of the respective valve 124, and fluid is prevented from flowing from the first common manifold inlet 116A to the plurality of outlets 120 (i.e., the first common manifold inlet 116 is sealed). In other words, at least in this example, positive pressure is therefore directed from the second common manifold inlet 116B or the third common manifold inlet 116C to the respective outlet 120 via the respective exit aperture 236. Conversely, when the respective valve 124 is in the second state, the portion of the valve 124 is spaced from the respective valve seat 132, such that the third port 264 is blocked and the second port 184 of the valve 124 is fluidly connected to the first port 182 of the valve (and, as such, the source of vacuum pressure supplying the first common manifold inlet 116A). In turn, fluid is allowed to flow from the first common manifold inlet 116A to the common manifold outlets 120 via the second port 184 of the respective valve (if the configurable area 262 of the first flow manipulation gasket 128B permits), and fluid is prevented from flowing from the second and third common manifold inlets 116B, 116C to the common manifold outlets 120. In other words, at least in this example, negative pressure is therefore directed from the first common manifold inlet 116A to the respective outlet 120 via the respective first port 182.

In this example, the solenoid valve occupies the first state when de-energized, and responsive to energization of the solenoid valve, the solenoid valve moves from the first state to the second state. However, in other examples, the solenoid valve can occupy the first state when energized, and responsive to the de-energization of the solenoid valve, the solenoid valve can move from the second state to the first state.

In some examples, the first flow manipulation gaskets 128A, 128B allow for a sub 3 mm pitch, which can be difficult to achieve using other track style sealing methods. In some examples, the first flow manipulation gaskets 128A, 128B can be removed from the manifold assembly 104 and replaced with different manipulation gaskets (i.e., gaskets having differently configured configurable areas). Thus, the functionality of the manifold can be changed or otherwise updated without the need to change the other components. For example, one or both of the first flow manipulation gaskets 128A, 128B can be removed and replaced with different manipulation gaskets without having to remove the plurality of valves 124 from the manifold body 112.

It will be appreciated that the components of the first manifold assembly 104 are coupled together in several ways. First, the end layer 150, the valve seat layer 154, and the interface layer 158 are coupled together via a plurality of fasteners (e.g., the plurality of threaded fasteners 300 best illustrated in FIG. 1). Second, the first flow manipulation gasket 128B can include a plurality of alignment holes 304 and the end layer 150 can include a plurality of alignment bosses 308 configured to be disposed in the alignment holes 304, respectively, to secure the first flow manipulation gasket 128B within the valve seat layer 154. Third, and likewise, the first flow manipulation gasket 128A can include a plurality of alignment holes 312 and the interface plate 204 can include a plurality of alignment bosses 316 configured to be disposed in the plurality of holes 312, respectively, to help secure the first flow manipulation gasket 128A to the interface plate 204.

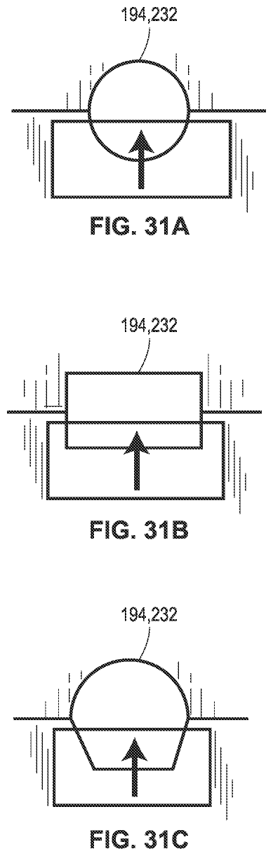

It will also be appreciated that the geometries of any of the components of the first manifold assembly 104 described herein can vary to control fluid flow in a different manner. First, as discussed above, the configurable areas 252, 262 of the first flow manipulation gaskets 128A, 128B can vary to permit or block fluid flow in a different manner. Second, the geometry of any of the energy directors 194, 232 can vary from what is illustrated in FIG. 31A. For example, any of the energy directors 194, 232 can instead have the geometry illustrated in FIG. 31B or FIG. 31C. It will be appreciated that this different geometry will cause the fluid to flow in a different manner than the geometry illustrated in FIG. 31A.

Finally, it will be appreciated that the second manifold assembly 108 includes similar or the same components as the first manifold assembly 104. Thus, the second manifold assembly 108 also generally includes a second manifold body 412, a second plurality of common inlets 416 formed in the second manifold body 412, a second plurality of outlets 420 formed in the second manifold body 412, a plurality of second valves 424 disposed in the second manifold body 412, and a pair of second flow manipulation gaskets 428 arranged within the second manifold body 412 and adjacent the plurality of second valves 424. However, these components of the second manifold assembly 108 are structurally similar or identical to these respective components of the first manifold assembly 104. Accordingly, further details regarding these components are omitted for the sake of brevity. At the same time, it will be appreciated that these components (e.g., the second flow manipulation gaskets 428) of the second manifold assembly 108 can vary from the respective components of the first manifold assembly 104.

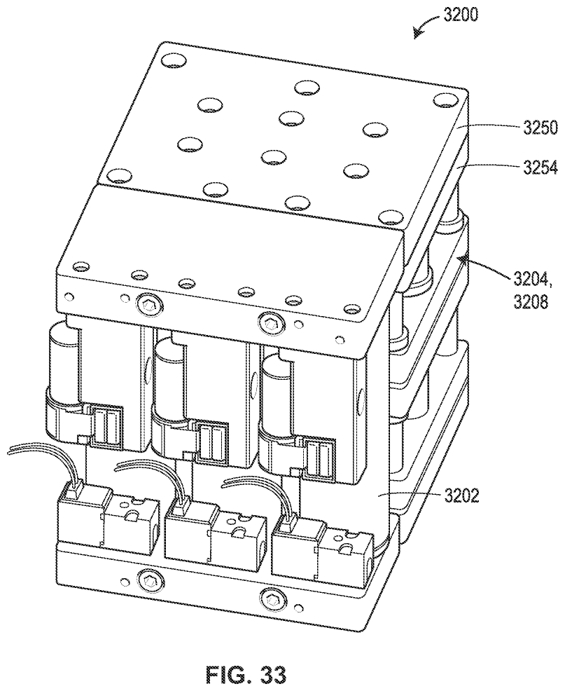

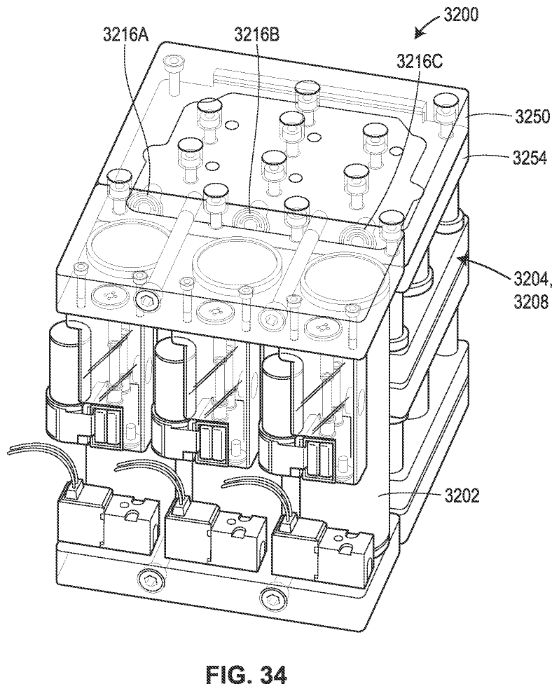

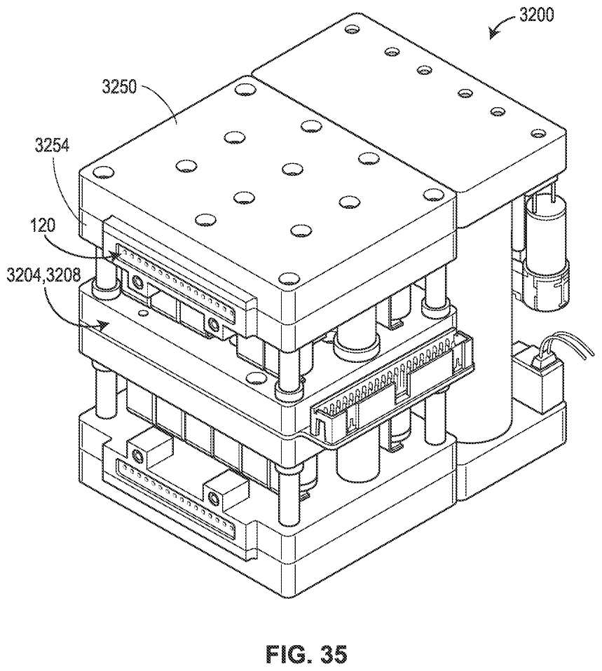

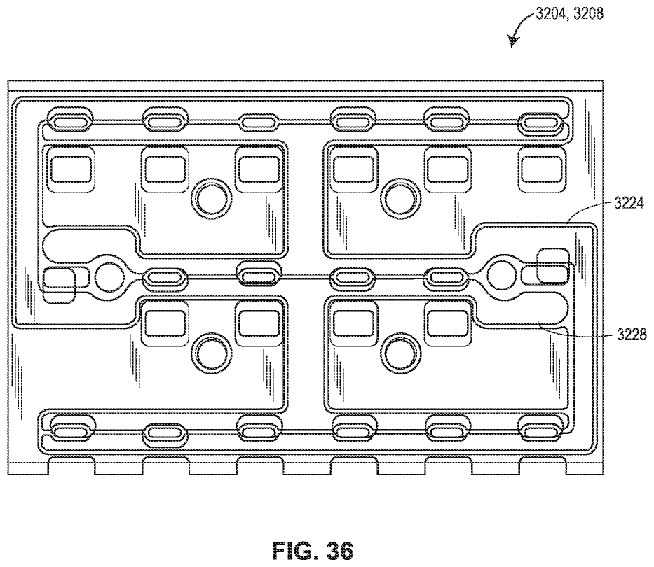

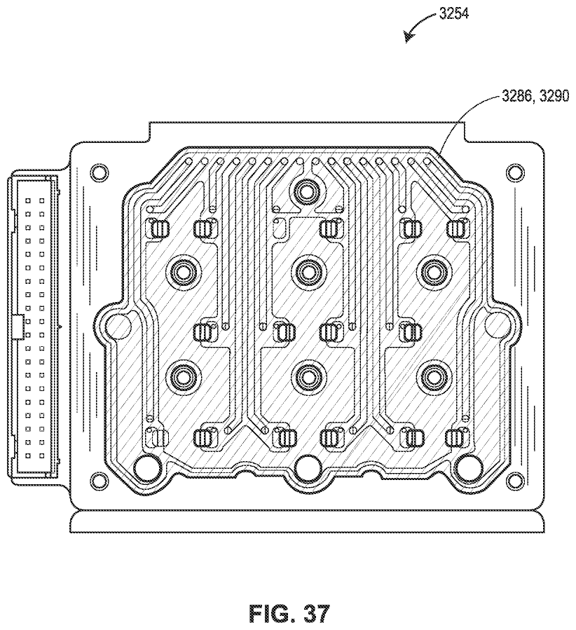

FIGS. 33-37 illustrate another example of a modular manifold 3200 that is constructed in accordance with the teachings of the present disclosure. The modular manifold 3200 is substantially identical to the modular manifold 100 described above, but for the following differences. First, as illustrated in FIGS. 33 and 34, the modular manifold 3200 includes additional components not included with the modular manifold 100, such as, for example, pressure tanks 3202 for the modular manifold 3200. Second, as illustrated in FIG. 36, the modular manifold 3200 includes an interface plate 3204 and a first flow manipulation gasket 3208 that is coupled to the interface plate 3204, like the modular manifold 100, but the interface plate 3204 and the first flow manipulation gasket 3208 are different from the interface plate 204 and the first manipulation gasket 128A of the modular manifold 100, respectively. More particularly, the interface plate 3204 has first and second channels 3224, 3228 that have a slightly different shape than the channels 224, 228 of the interface plate 204. And the flow manipulation gasket 3208 has a plurality of configurable areas that are different from the plurality of configurable areas 252 of the flow manipulation gasket 128A, such that the flow manipulation gasket 3208 will permit or block fluid flow in a different manner. Third, as illustrated in FIG. 37, the modular manifold 3200 has a valve seat layer 3254 that is different from the valve seat layer 154 of the modular manifold 100. More particularly, the valve seat layer 3254 has a first series of outlet channels 3286 and a second series of outlet channels 3290 that are different from the first and second series of outlet channels 186, 190 of the valve seat layer 154, such that fluid will be controlled in a different manner. Fourth, while the modular manifold 3200 has three common inlets 3216A, 3216B, and 3216C, like the modular manifold 100, the common inlets 3216A, 3216B, and 3216C are positioned in a different location than the common inlets 116A, 116B, and 116C. Indeed, as best illustrated in FIG. 34, the common inlets 3216A, 3216B, and 3216C are located on an underside of the end cap 3250 (which is otherwise identical to the end cap 150 described above). In this way, the common inlets 3216A, 3216B, and 3216C can interface directly (or more directly) with the pressure tanks 3202. In turn, it will be appreciated that the second and third common inlets 3216B, 3216C can be routed to the center of the modular manifold 3200 (and, more particularly, the interface place 3204) via a flow connector, tubing, and independent channels formed in the valve seat layer 3254 (not shown).

1. A modular manifold for use with a microfluidic chip, the modular manifold comprising:
a first manifold assembly, comprising:
a first manifold body;
a first plurality of common inlets formed in the first manifold body;
a first plurality of outlets formed in the first manifold body;
one or more first valves disposed in the first manifold body, each of the one or more first valves movable between a first state and a second state, wherein in the first state, the respective first valve engages a respective first valve seat carried by the first manifold body, thereby preventing fluid from flowing from a first one of the first plurality of common inlets to the first plurality of outlets but allowing fluid to flow from a second one of the first plurality of common inlets to the first plurality of outlets, and wherein in the second state, the respective first valve is spaced from the respective first valve seat, thereby preventing fluid from flowing from the second one of the plurality of common inlets to the first plurality of outlets but allowing fluid to flow from the first one of the plurality of common inlets to the first plurality of outlets; and
a first flow manipulation gasket arranged within the first manifold body, the flow manipulation gasket comprising a first gasket body configured to engage the first manifold body and one or more first flow apertures formed in the first gasket body, the one or more first flow apertures arranged in a first pre-determined pattern so as to route fluid flowing to the plurality of outlets along one or more desired/pre-determined flow paths;
a second manifold assembly, comprising:
a second manifold body;
a second plurality of common inlets formed in the second manifold body;
a second plurality of outlets formed in the second manifold body;
one or more second valves disposed in the second manifold body, each of the one or more second valves movable between a first state and a second state, wherein in the first state, the respective second valve engages a respective second valve seat carried by the second manifold body, thereby preventing fluid from flowing from a first one of the second plurality of common inlets to the second plurality of outlets but allowing fluid to flow from a second one of the second plurality of common inlets to the second plurality of outlets, and wherein in the second state, the respective second valve is spaced from the respective second valve seat, thereby preventing fluid from flowing from the second one of the second plurality of common inlets to the second plurality of outlets but allowing fluid to flow from the first one of the second plurality of common inlets to the second plurality of outlets; and
a second flow manipulation gasket arranged within the second manifold body, the flow manipulation gasket comprising a second gasket body configured to engage the second manifold body and one or more second flow apertures formed in the second gasket body, the one or more second flow apertures arranged in a second pre-determined pattern so as to route fluid flowing to the plurality of outlets along one or more desired/pre-determined flow paths; and
a printed circuit board captured between the first manifold assembly and the second manifold assembly.

2. The modular manifold of claim 1, wherein each of the first and second manifold bodies comprises an interface layer and a valve seat layer coupled to the interface layer, the valve seat layer defining the one or more valve seats.

3. The modular manifold of claim 2, wherein the valve seat layer has a first side, a second side opposite the first side, and one or more through apertures extending between the first side and the second side, the first side including the one or more valve seats, and the second side comprising a plurality of outlet channels fluidly connecting the one or more through apertures and the plurality of outlets.

4. The modular manifold of claim 1, wherein each of the first and second manifold bodies comprises an interface plate, wherein the interface plate comprises a plurality of inlet channels connecting the first and second common manifold inlets and an upstream end of the one or more valves.

5. The modular manifold of claim 4, wherein the interface plate is disposed in the interface layer.

6. The modular manifold of claim 1, wherein each of the first and second manifold bodies further comprises an end layer coupled to the valve seat layer.

7. The modular manifold of claim 6, wherein the first flow manipulation gasket is arranged between the valve seat layer and the end layer of the first manifold body.

8. The modular manifold of claim 2, wherein the first flow manipulation gasket is carried by the interface layer of the first manifold body.

9. The modular manifold of claim 8, wherein the first flow manipulation gasket is arranged between a portion of the interface layer and the interface plate of the first manifold body.

10. The modular manifold of claim 1, wherein the second pre-determined pattern is different from the first pre-determined pattern.

11. The modular manifold of claim 1, wherein the first plurality of outlets are formed in the valve seat layer of the first manifold body and the second plurality of outlets are formed in the valve seat layer of the second manifold body.

12. The modular manifold of claim 1, wherein the first plurality of common inlets are formed in the interface layer of the first manifold body.

13. The modular manifold of claim 1, wherein each of the one or more first valves and the one or more second valves is a solenoid valve, wherein in the first state, the respective solenoid valve is de-energized, and wherein responsive to energization of the respective solenoid valve, the respective solenoid valve moves from the first state to the second state.

14. The modular manifold of claim 1, wherein the first flow manipulation gasket is removable and replaceable with a third flow manipulation gasket having one or more third flow apertures arranged in a second-predetermined manner different from the first pre-determined manner.

15. The modular manifold of claim 14, wherein the flow manipulation gasket is removable without removing the one or more valves from the manifold body.

16. A method of manufacturing a modular manifold assembly for use with a microfluidic chip, the method comprising;
providing a manifold body comprising one or more valve seats, a first common inlet, a second common inlet, and plurality of outlets;
disposing one or more valves in the manifold body, each of the one or more valves movable between a first state and a second state, wherein in the first state, the respective valve engages a respective valve seat of the one or more valve seats, thereby preventing fluid from flowing from the first common manifold inlet to the plurality of outlets but allowing fluid to flow from the second common manifold inlet to the plurality of outlets and, and wherein in the second state, the respective valve is spaced from the respective valve seat of the one or more valve seats, thereby allowing fluid to flow from the first common manifold inlet to the plurality of outlets but preventing fluid from flowing from the second common manifold inlet to the plurality of outlets;
forming a first flow manipulation gasket comprising a first gasket body and one or more first flow apertures formed in the first gasket body, the one or more first flow apertures arranged in a first pre-determined manner so as to route fluid flowing to the plurality of outlets along one or more first desired/pre-determined flow paths;
arranging the flow manipulation gasket within the manifold body and adjacent the one or more valves;
removing the first flow manipulation gasket from the manifold body;
forming a second flow manipulation gasket comprising a second gasket body and one or more second flow apertures formed in the second gasket body, the one or more second flow apertures arranged in a second pre-determined manner so as to route fluid flowing to the plurality of outlets along one or more second desired/pre-determined flow paths;
arranging the second flow manipulation gasket within the manifold body and adjacent the one or more valves.

17. The method of claim 16, wherein the first flow manipulation gasket is removable from the manifold body without removing the one or more valves.

18. The method of claim 16, wherein the first and second flow manipulation gaskets are formed using an additive manufacturing technique.

19. The method of claim 16, wherein the manifold body is formed using an additive manufacturing technique.
